(19) United States
(12) Patent Application Publication
(10) Pub. No.: US 2024/0202434 A1
(43) Pub. Date: Jun. 20, 2024

(54) APPARATUS FOR ANALYZING CHART DATA USING ARTIFICIAL INTELLIGENCE AND METHOD THEREOF

(71) Applicant: BRAIN VENTURES USA INC, Wilmington, DE (US)

(72) Inventors: Won Hoi Kim, Seongnam-si (KR); Jun Ho Lee, Seongnam-si (KR); Seo Ji Lee, Seongnam-si (KR)

(73) Assignee: BRAIN VENTURES USA INC, Wilmington, DE (US)

(21) Appl. No.: 18/088,791

(22) Filed: Dec. 27, 2022

(30) Foreign Application Priority Data
Dec. 20, 2022 (KR) 10-2022-0178989

(51) Int. Cl. G06F 40/177; G06T 7/60; G06T 7/73

(52) U.S. Cl. CPC G06F 40/177; G06T 7/60; G06T 7/73

(57) ABSTRACT

Disclosed is an apparatus for analyzing chart data, comprising a chart confirmation portion for identifying the type of the chart to be analyzed; a data confirmation portion for identifying objects shown in the chart in a manner corresponding to the type of the chart and values of the objects; a table data generation portion for converting data related to the chart into a table data format to generate a table corresponding to the chart; and a summary generation portion for generating an analysis result of the chart by using table data.

### CROSS-REFERENCE TO RELATED APPLICATIONS

This application claims priority to Korean Patent Application 10-2022-0178989, filed on Dec. 20, 2022, in the Korean Intellectual Property Office, the disclosure of which is incorporated herein by reference in its entirety.

### TECHNICAL FIELD

The present invention relates to an apparatus for analyzing chart data by using artificial intelligence and a method thereof and, more particularly, to an apparatus for analyzing chart data by using artificial intelligence that analyzes chart data and provides the chart data to a user in text or voice so that the user can conveniently grasp the chart data in an image state, and a method thereof.

### BACKGROUND ART

A chart is meant to arrange various data for easy understanding, and various types of a bar chart, a line chart and a pie chart are used. The chart visually displays data using a graph such that a user can conveniently check data, and provides various information such as a trend that can be identified by a user by comparing data displayed on the chart. For example, a user can determine a change in population, a change in real estate prices, or a change in stock quotations on a time unit such as day, week, month and year.

Meanwhile, in recent years, there are many cases in which artificial intelligence replaces human tasks due to the development of artificial intelligence technology. For example, artificial intelligence is used to assist doctors in the medical field or buy and sell stocks in the financial field, and also used as an assistant.

In order to understand the information provided by a chart, a user needs to go through the process of analyzing the contents displayed on the chart. However, each user has a different level of education, and visually impaired people can have difficulty in seeing image data. Therefore, a way to use artificial intelligence technology to analyze charts is required.

### SUMMARY OF INVENTION

### TECHNICAL PROBLEM

The present invention relates to an apparatus and a method for analyzing chart data by using artificial intelligence.

The present invention also relates to an apparatus and a method for providing chart data analyzed by using artificial intelligence in the form of a text or voice.

### SOLUTION TO PROBLEM

### ADVANTAGEOUS EFFECTS OF INVENTION

The present invention may generate analysis data on various types of chart data such that a user can confirm the contents of the chart even when the chart data is not easily interpreted. In addition, analysis data on the chart may be provided in the form of a text or voice such that a user can conveniently confirm the contents of the chart according to their selection. In addition, when the analysis data on the chart are expressed in sentences, a user can learn by using an artificial intelligence technology such as deep learning to continuously improve their sentence analysis and expression skills.

### BRIEF DESCRIPTION OF DRAWINGS

FIG. 1 is a diagram showing the configuration of the apparatus for analyzing chart data according to an embodiment of the present invention.

FIG. 2 is a diagram showing the configuration of the conversion portion of the apparatus for analyzing chart data according to an embodiment of the present invention.

FIG. 3 is a diagram explaining chart data according to an embodiment of the present invention.

FIGS. 4A to 4D are diagrams explaining the operation of the data confirmation portion of the apparatus for analyzing chart data according to an embodiment of the present invention.

FIG. 5 is a diagram explaining the operation of the table data generation portion of the apparatus for analyzing chart data according to an embodiment of the present invention.

FIG. 6 is a flowchart showing the operation of the apparatus for analyzing chart data according to an embodiment of the present invention.

### MODE FOR INVENTION

Hereinafter, embodiments of the present invention will be described in detail together with drawings. In describing the present invention, if it is determined that a detailed description of a related function or configuration commonly known in the art would unnecessarily obscure the gist of the present invention, the detailed description will be omitted.

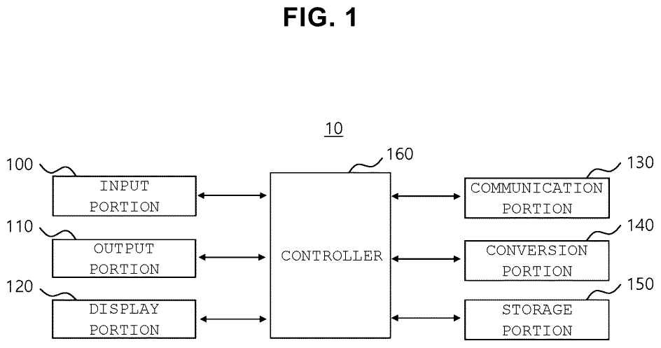

FIG. 1 is a diagram showing the configuration of the apparatus for analyzing chart data (10) according to an embodiment of the present invention.

Referring to FIG. 1, the apparatus for analyzing chart data (10) of the present invention comprises an input portion (100), a communication portion (130), a conversion portion (140), a storage portion (150) and a controller (160), and may additionally comprise an output portion (110) and a display portion (120) .

The input portion (100) functions to convert a physical input from the outside into a certain electrical signal and may receive a user's input or sound such as a user's touch, push action and voice. Also, the input portion (100) may be implemented by using various forms of buttons, a touch sensor that receives touch inputs, a proximity sensor that receives approaching motions, etc.

The output portion (110) is provided to output information to the outside by using a physical means such as voice and sound, and a speaker may be an example thereof.

The display portion (120) displays related data to be processed such that user can check the data. For example, the display portion (120) and input portion (100) may be implemented as a touch panel.

The communication portion (130) is provided to communicate with other external devices and, specifically, may comprise all or part of a wireless Internet unit (not illustrated), a mobile communication portion (not illustrated), a short-distance communication portion (not illustrated) and a wired communication portion (not illustrated). The wireless Internet unit obtains or transmits data by accessing the wireless Internet, and the mobile communication portion may access the mobile communication network and communicate according to various mobile communication standards (e.g., Long Term Evolution (LTE), 5rd Generation (5G) and 5rd Generation Partnership Project (5GPP)) . In addition, the short-distance communication portion is provided for short-distance communication such as Bluetooth or Wi-Fi, and the wired communication portion is an interface device that may be connected to other devices by wire.

The conversion portion (140) converts chart data in an image state into table data and generates analysis data on the chart data by using various data included in the table data. For example, the conversion portion (130) may generate a summary by interpreting the chart data.

The storage portion (150) stores various programs such as programs related to neural networks and applications implementing particular functions and may be implemented as a built-in storage device such as Random Access Memory (RAM), a hard disk and a memory card.

The controller (160) generally controls the apparatus for analyzing chart data (10) of the present invention, e.g., by letting the display portion (120) visually display the analysis data on the chart data in an image state generated by the conversion portion (140) or letting the output portion (110) output a voice.

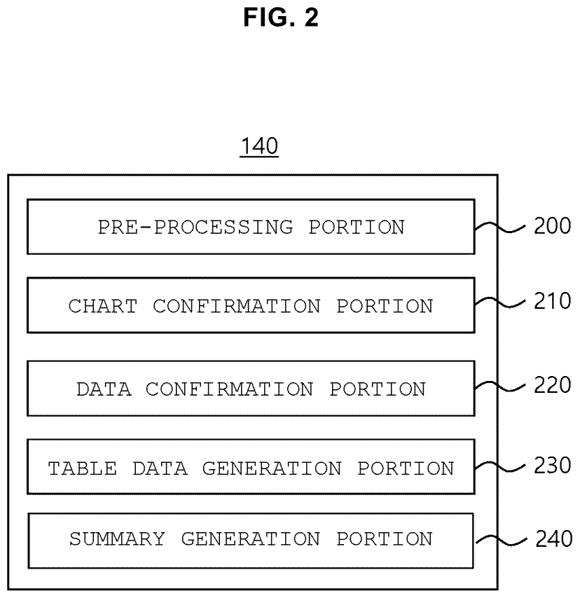

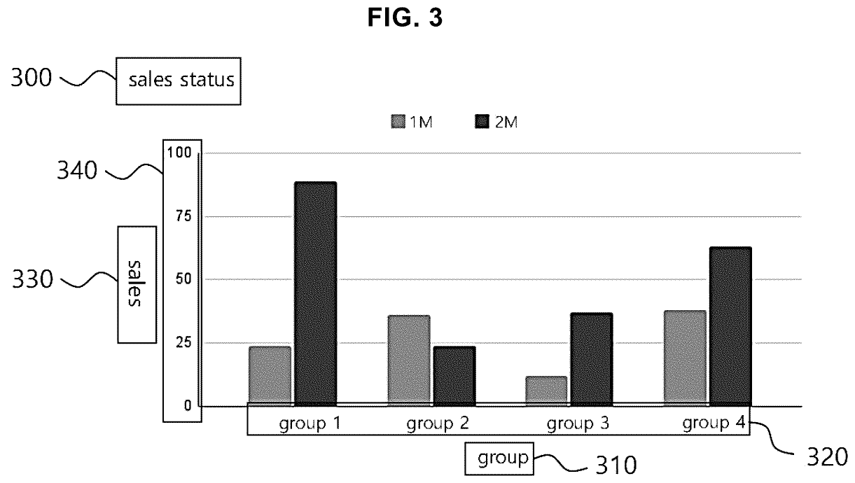

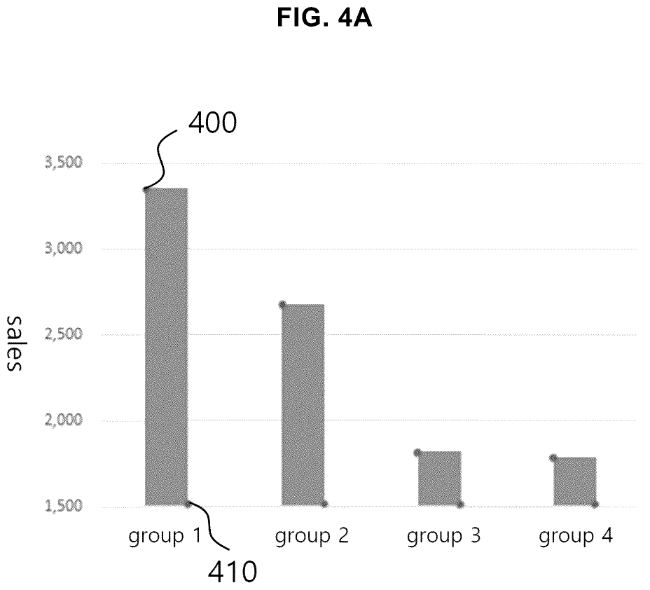

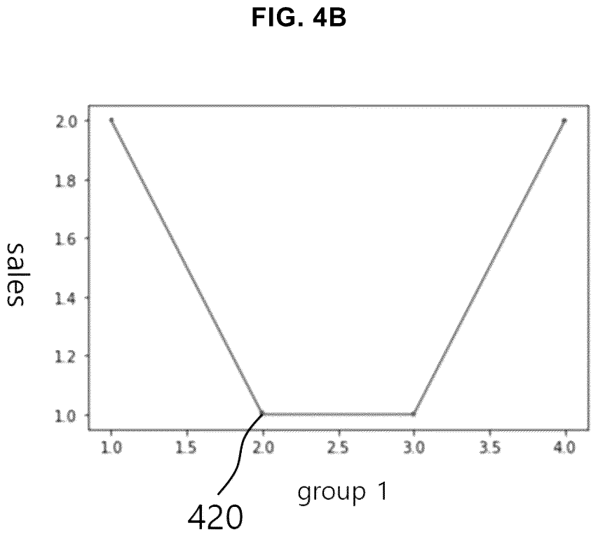

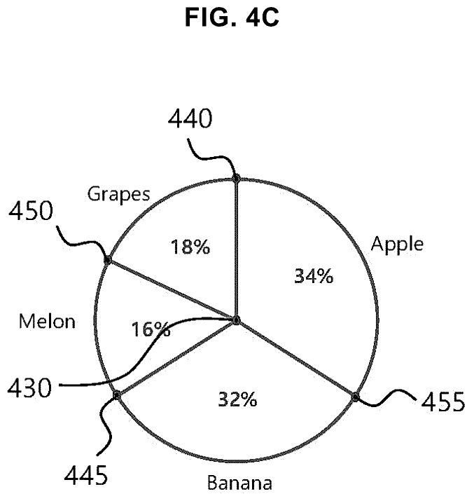

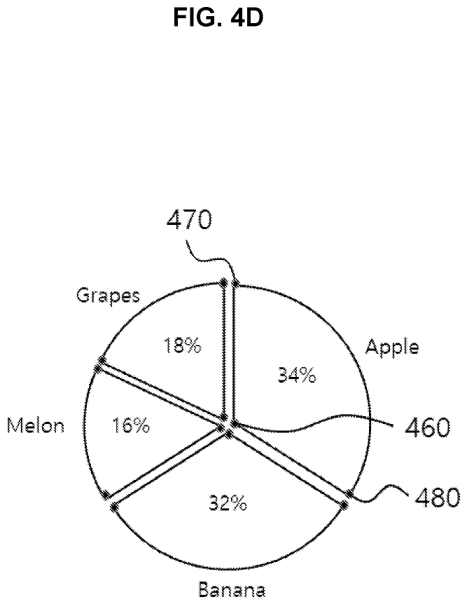

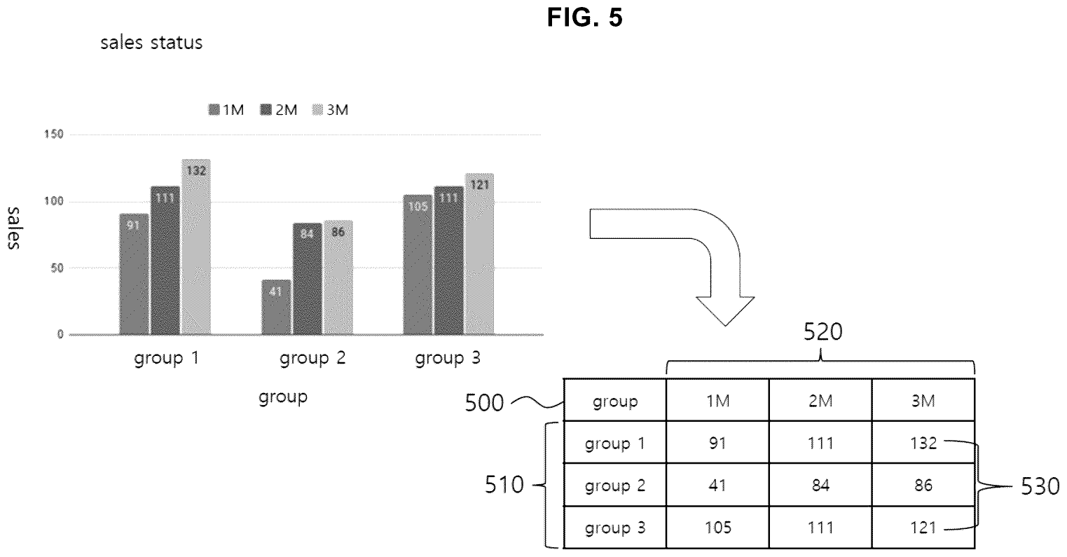

FIG. 2 is a diagram showing the configuration of the conversion portion (140) of the apparatus for analyzing chart data (10) according to an embodiment of the present invention. FIG. 3 is a diagram explaining chart data according to an embodiment of the present invention. FIGS. 4A to 4D are diagrams explaining the operation of the data confirmation portion (220) of the apparatus for analyzing chart data (10) according to an embodiment of the present invention. FIG. 5 is a diagram explaining the operation of the table data generation portion (230) of the apparatus for analyzing chart data (10) according to an embodiment of the present invention.

Hereinafter, a bar chart, a line chart and a pie chart will be reviewed as a chart, and methods identical or similar those applied to these charts may be applied to other types of charts.

Referring to FIG. 2, the conversion portion (140) of the apparatus for analyzing chart data (10) of the present invention comprises a chart confirmation portion (210), a data confirmation portion (220), a table data generation portion (230) and a summary generation portion (240) and may further comprise a pre-processing portion (200).

The pre-processing portion (200) processes predetermined chart property information included in chart data in an image state to be located at a specific position on a predetermined chart. For example, referring to FIG. 3, the predetermined chart property information comprises a chart title (300), an X-axis title (310), X-axis configuration items (320), a Y-axis title (330) and Y-axis configuration values (340). The pre-processing portion (200) processes the predetermined chart property information such that the chart title (300) is located at the top of the chart, the X-axis composition items (320) and X-axis title (310) are located at the bottom of the chart, and the Y-axis title (330) and Y-axis configuration values (340) are located on one side of the chart. If a chart such as a pie chart does not include information on the X-axis and Y-axis, the pre-processing portion (200) processes items by which the chart may be identified, such as the chart title.

The chart confirmation portion (210) confirms the type of the chart to be analyzed. For example, the chart confirmation portion classifies the type of the chart to be analyzed among a bar chart, a line chart and a pie chart. In order to do so, the chart confirmation portion (210) may use artificial intelligence technology related to a chart type classification model capable of classifying the type of a chart through learning.

The data confirmation portion (220) is provided to identify objects shown in the chart. At this time, the object is bars in a bar chart, pivot points indicating where the trend on a line chart changes, and sectors each comprising two radii and one arc in a pie chart.

The data confirmation portion (220) may use artificial intelligence technology capable of identifying objects shown in each chart through learning and use different object identification models for different types of charts.

The data confirmation portion (220) extracts point data for objects shown in each chart to identify the objects, in consideration of the types of the charts, as shown in FIGS. 4A to 4D, and the point data comprises the location data of the extracted points.

In the case of a bar chart, in order to identify bars as objects, as shown in FIG. 4A, one point (400) at the top of each bar and the other point (410) at the bottom of each bar are extracted, and the two points are used to constitute a bar.

In the case of a line chart, as shown in FIG. 4B, the points (420) indicating where the trend changes are extracted, the positions of the pivot points are predicted, and an embedding layer is used such that the positions of points on one line are disposed close and the positions of points on another line are disposed apart. The new positions of the points obtained through such process are called feature embedding, and a union-find algorithm is performed by using the feature embedding values in order to group the points on the same line. In this case, a hierarchical clustering unsupervised learning method may be used. When there are a plurality of lines, points belonging to several lines are treated as singular values by a clustering algorithm and are determined as intersection points.

In the case of a pie chart, as shown in FIGS. 4C and 4D, the center points (430, 460) of the sectors and points (440, 445, 450, 455, 470, 480) where two radii and one arc meet are extracted. In addition, in order to identify the objects, a procedure for identifying the objects is performed by distinguishing between a case where the sectors have one center point (430), as shown in FIG. 4C, and a case where the sectors have a plurality of center points (460), as shown in FIG. 4D. When the sectors have one center point (430), the center point (430) of the sectors and the points (440, 445, 450, 455) forming the arcs are mapped by 1:N such that one center point may form at least one sector. Therefore, the points constituting each arc are aligned in a clockwise direction, and the center point (430) of the sectors and two adjacent points (440, 450) constituting an arc are grouped in order to identify the sector.

When the sectors have a plurality of center points (460), the radius (r^{s}) of each sector is determined by using the center point (460) of each sector, the points constituting the arc (470, 480), and the center points of all sectors and points constituting the arcs, and the radius of the circle (t) is determined by using the center point of the circle. The radius may be determined by using the coordinates of the center point of the sector, the points constituting the arc, the center point of the circle, etc. Thereafter, when the points constituting the arc are aligned in a clockwise direction, and each point satisfies [Equation 1], [p_{c}, p_{arc}_{ₙ}, p_{arc}_{ₙ₊₁}] are grouped to identify the sector.

$$\frac{dis ( {p}_{c} , {p}_{{arc}_{n}} ) - r *}{r *} < t \qquad [ Equation 1 ]$$

$$and$$

$$\frac{dis ( {p}_{c} , {p}_{{arc}_{n}} ) - r *}{r *} < t .$$

wherein p_{c} is the center point (460) of any one of the sectors,
p_{arc}_{ₙ} is any one point (470) constituting the n^{th} sector,
p_{arc}_{ₙ₊₁} is the other point (480) constituting the n^{th} sector,
dis(p_{c},p_{arc}_{ₙ}) is a distance between p_{c} and p_{arc}_{ₙ}, and
dis(p_{c},p_{arc}_{ₙ₊₁}) is a distance between p_{c} and p_{arc}_{ₙ₊₁}.

The data confirmation portion (220) identifies objects shown in the chart and then determines a value corresponding to each object. For example, the data confirmation portion (220) identifies Y-axis values of each bar corresponding to X-axis items on a bar chart, Y-axis values of each line corresponding to X-axis items on a line chart, and a value of each sector on a pie chart. If the chart indicates the values of bars, lines or sectors, the indicated values may be determined as the value of each bar, line or sector. If the chart does not indicate the values of bars, lines or sectors, the value of each bar, line or sector is estimated.

In view of the process of estimating the values, in the case of a bar chart and a line chart, the data confirmation portion (220) uses the coordinate values to determine the minimum value (Yₘᵢₙ) described at the bottom of the Y-axis of each chart and its position (r_{bottom}) and the maximum value (Yₘₐₓ) described at the top of the Y-axis and its position (rₜₒₚ). Thereafter, the position range value (Object_{range}) of each bar and line is determined by using the position of each bar and line corresponding to the X-axis item, and the Y-axis value (Objectᵥₐₗᵤₑ) of each bar or line corresponding to the X-axis item is determined by using [Equation 2]. The position range of a line may be determined by understanding that the bar is located at the point of the line corresponding to the X-axis item.

$${Object}_{value} = \frac{{Y}_{range} - {Object}_{range}}{{r}_{range}} + {Y}_{min} \qquad [ Equation 2 ]$$

$${Y}_{range} = {Y}_{max} - {Y}_{min}$$

$$wherein ,$$

$${r}_{range} = {r}_{top} - {r}_{bottom} ,$$

$${Object}_{range} = {Object}_{Top} - {Object}_{Bottom} ,$$

$${Object}_{Top}$$

is a position corresponding to the top of a bar or a line, and
Object_{Bottom} is a position corresponding to the bottom of a bar or a line.

In the case of a sector, the data confirmation portion (220) calculates the angle of the center of each sector by using [Equation 3], compares the angles of the centers of the sectors and considers the ratio of the angles of the centers of the sectors to determine a value corresponding to each sector.

$$cos θ = \frac{2 {r}^{2} - {c}^{2}}{2 {r}^{2}} , \qquad [ Equation 3 ]$$

wherein θ is the angle of a sector,
c is a distance between the two points constituting the arc of each sector, and
r is a distance between the center point of each sector and a point constituting the arc.

The table data generation portion (230) creates a table related to a chart by using chart data. In order to do so, the table data generation portion (230) converts chart data into a table data format and generates a table corresponding to the chart. Referring to FIG. 5, the table generated by the table data generation portion (230) comprises an X-axis title (500), X-axis items (510), legends (520), and Y-axis values (530). Since the legends are displayed on the chart such that their colors and shapes correspond to those on a bar, a line, a sector, etc., table data may be created by confirming the data corresponding to the legends. The created table data may be saved in a JSON file format.

The summary generation portion (240) generates an analysis result of chart data by using table data generated by using the chart data, and for example, the analysis result may be generated in the form of a summary on the chart data. The summary generation portion (240) uses a transformer-based model for generating text data and a template-based approach and a neural network model for generating a summary.

A template-based approach refers to a pre-determined template in the structure of sentences to be created. For example, the following template may be used to create a chart analysis summary. The summary may be generated in various languages including Korean, and, when the template is written in Korean, the summary may be generated in Korean.
(i) Explain what the chart is about, e.g., by describing “This chart shows [Chart Title] regarding from [X-axis Title] [X-axis item [0]] to [X-axis item [−1]].” At this time, [X-axis item [0]] indicates the first item of the X-axis, and [X-axis item [−1]] indicates the last item of the X-axis.
(ii) Focus on the components of the chart and describe the chart itself, e.g., by describing “The unit of measurement in this chart is [Y-axis title].”
(iii) Interpret the information on the chart. For example, a trend change may be explained by using numerical information on the chart, e.g., by describing “ [Legend [0]] [Y-axis title] of [X-axis item [0]] is increasing up to [X-axis item [−1]].”
(iv) Describe an opinion comparing specific values, e.g., by describing “[Legend [0]] of [X-axis item [0]] has more [Legend [0] [0]]-[Legend[1][0]] [Y-axis title] than [Legend [1] ].” At this time, [Legend[0][0]] and [ Legend [1][0] ] indicate a method of storing variables (values) in a computer and are in the form of a list.
(v) Conclude with a chart-based conclusion, summary or implication.

In (iii) or (iv), the template may be extended to explain the chart such that different items may be compared in a categorical chart (if it is a simple graph or has only one legend), and, when the X-axis indicates time, the trend of the data may be identified, and data at different points of time may be compared. In addition, if there is no clear trend, data may be compared with data at a certain point, or the maximum or minimum value of the data may be described.

The summary generation portion (240) may train a neural network model by using label (correct answer) data based on a template, and, when the final summary is generated, data variables indicated by [] such as [X-axis title] are converted into data constituting the chart to create a summary comprising information about the chart. In addition, the summary generation portion (240) may include or exclude a specific item as a component of the chart. For example, table data comprising chart components and data values are arranged in a record format comprising the following information:

$${R}_{i} = [ {r}_{i} ( 0 ) ; {r}_{i} ( 1 ) ; {r}_{i} ( 2 ) ; {r}_{i} ( 3 ) ; ] ,$$

wherein rᵢ(0) is the name of the column, such as group in FIG. 5,
rᵢ(1) is the data value, such as Group 1 in FIG. 5,
rᵢ(2) is whether the data value is mentioned in the summary (True/False), and
rᵢ(3) is the type of the chart (categorical chart/trend chart).

The summary generation portion (240) changes data information into the above-described record and inputs the output value of the encoder to a binary classification model to determine whether to mention the data information (record) in the summary. That is, the summary generation portion inputs

$${R}_{i} = [ {r}_{i} ( 0 ) ; {r}_{i} ( 1 ) ; {r}_{i} ( 2 ) ; {r}_{i} ( 3 ) ; ]$$

into the encoder and inputs the output value of the encoder into the binary classification model. The output value of the encoder and the output value of the binary classification model are input into a decoder, and the decoder predicts data information and predicts previous data information from a summary sequence to output characters for generating a summary. At this time, position embedding and a method of substituting data variables are introduced into the decoder model. The output of the decoder is input into a neural network such as softmax to generate a summary. Since the generated summary is based on a template, the data variables described in the template are converted into data constituting the chart to generate a summary comprising information about the chart.

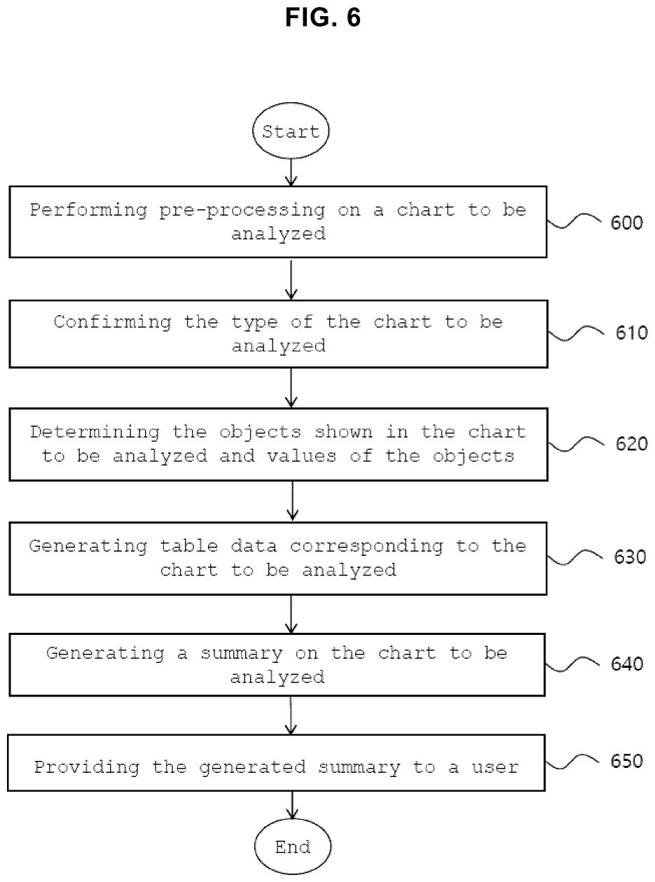

FIG. 6 is a flowchart showing the operation of the apparatus for analyzing chart data (10) according to an embodiment of the present invention.

Referring to FIG. 6, when a chart image is input or received from the outside, the pre-processing portion (200) performs pre-processing on the chart to be analyzed such that predetermined chart property information contained in the chart data is located at a certain position on a predetermined chart (600). At this time, when the chart property information is located at a particular position on the predetermined chart, the pre-processing process may be omitted. When the pre-processing is completed, the chart confirmation portion (210) confirms the type of the chart to be analyzed among a bar chart, a line chart and a pie chart (610). When the type of the chart is confirmed, the data confirmation portion (210) determines objects such as bars, pivot points and sectors shown in the chart to be analyzed and values of the objects (620). When the objects shown in the chart and their values are determined, the table data generation portion (230) generates table data corresponding to the chart by using the data of the chart to be analyzed (630), and the summary generation portion (240) generates a summary on the chart to be analyzed by using the generated table data (640). Thereafter, the controller (160) provides the generated summary to a user through the output portion (110) or the display portion (120) (650).

### Industrial Applicability

Meanwhile, although specific embodiments have been described in the detailed description of the present invention, various modifications thereto are possible, unless departing from the scope of the present invention.

Therefore, the scope of the present invention is not limited to the described embodiments, and should be defined by not only the scope of the claims to be described below, but also those equivalents to the scope of these claims.

Description of Numerals

| | |
|---|---|
| 100: Input portion | 110: Output portion |
| 120: Display portion | 130: Communication portion |
| 140: Conversion portion | 150: Storage portion |
| 160: Controller | |

1. An apparatus for analyzing chart data, comprising a processor configured to:
identify types of a bar chart, a line chart, and a pie charta chart confirmation portion for to be analyzed;
identify objects shown in the charts and values of the objects in a manner corresponding to the types of the charts;
convert data related to the charts into a table data format and generate respective tables corresponding to the charts; and
generate analysis data on the charts by using the tables; and
provide the analysis data to a user by using voice,
wherein, the objects shown in the bar chart are bars, and the processor extracts one point at the top of a bar and the other point at the bottom of the bar and uses the two points to identify the bar,
wherein, the objects shown in the line chart are pivot points, and the processor extracts at least one of the points where the trend on a line chart changes, predicts the positions of the pivot points, uses an embedding layer such that the positions of points on one line are disposed close and the positions of points on another line are disposed apart, thereby determining the feature embedding values on the new positions of the points, and performs a union-find algorithm by using the feature embedding values to group the points on the same line,
wherein, the objects shown in the pie chart are sectors each comprising a plurality of radii and one arc, and the processor extracts a center point of the sector and a plurality of points where a plurality of radii and one arc meet, and the center point of each sector and adjacent different points constituting the arc are grouped to confirm the sector,
wherein the charts do not indicate the values of the objects and for the bar chart and the line chart, the processor determines the values by using [Equation 2],
$${Obect}_{value} = \frac{{Y}_{range} - {Object}_{range}}{{r}_{range}} + {Y}_{min}$$
wherein Objectᵥₐₗᵤₑ is the values of objects
$${Y}_{range} = {Y}_{max} - {Y}_{min} ,$$
Yₘₐₓ is the value at the top of the Y-axis of the chart
Yₘᵢₙ is the value at the bottom of the Y-axis of the chart
r_{range}=rₜₒₚ−r_{bottom}
rₜₒₚ is the position of the maximum value of at the top of the Y-axis of the chart,
r_{bottom} is the position of minimum value of the bottom of the Y-axis of the chart,
$${Object}_{range} = {Object}_{Top} - {Object}_{Bottom} ,$$
Object_{Top} is a position corresponding to the top of objects,
Object_{Bottom} is a position corresponding to the bottom of objects,
for the pie chart, the processor calculates the angle of the center of each sector by using [Equation 3], compares the angles of the centers of the sectors and considers the ratio of the angles of the centers of the sectors to determine a value corresponding to each sector
$$cos θ = \frac{2 {r}^{2} - {c}^{2}}{2 {r}^{2}} , \qquad [ Equation 3 ]$$
wherein θ is the angle of sector,
c is a distance between the two points constituting the arc of each sector, and
r is a distance between the center point of each sector and a point constituting the arc.

2-4. (canceled)

5. The apparatus for analyzing chart data of claim 1,
wherein, the center point of the sector is plural, and
the processor uses the distance between the center point of any one sector and each of different points constituting any one arc, the radius of the sector and the radius of the circle using the center point of the circle such that the center point of the sector and different points constituting the arc satisfying a predetermined condition are grouped to confirm the sector.

6-7. (canceled)

8. A method for analyzing chart data, the method comprising the steps of:
confirming types of a bar chart, a line chart, and a pie chart to be analyzed;
identifying objects shown in the charts in a manner corresponding to the types of the charts;
confirming values of the objects;
converting data related to the charts into a table data format to generate respective tables corresponding to the charts; and
generating an analysis result of the charts by using the tables; and
providing the analysis result to a user by using voice.
wherein the objects shown in the bar chart are bars, and a processor extracts one point at the top of a bar and the other point at the bottom of the bar and uses the two points to identify the bar,
wherein the objects shown in the line chart are pivot points, and the processor extracts at least one of the points where the trend on a line chart changes, predicts the positions of the pivot points, uses an embedding layer such that the positions of points on one line are disposed close and the positions of points on another line are disposed apart, thereby determining the feature embedding values on the new positions of the points, and performs a union-find algorithm by using the feature embedding values to group the points on the same line,
wherein the objects shown in the pie chart are sectors each comprising a plurality of radii and one arc, and the processor extracts a center point of the sector and a plurality of points where a plurality of radii and one arc meet, and the center point of each sector and adjacent different points constituting the arc are grouped to confirm the sector,
wherein the charts do not indicate the values of the objects and for the bar chart and the line chart, the processor determines the values by using [Equation 2],
$${Object}_{value} = \frac{{Y}_{range} - {Object}_{range}}{{r}_{range}} + {Y}_{min} \qquad [ Equation 2 ]$$
wherein Objectᵥₐₗᵤₑ is the values of objects
$${Y}_{range} = {Y}_{max} - {Y}_{min} ,$$
Yₘₐₓ is the value at the top of the Y-axis of the chart
Yₘᵢₙ is the value at the bottom of the Y-axis of the chart
$${r}_{range} = {r}_{top} - {r}_{bottom} ,$$
rₜₒₚ is the position of the maximum value of at the top of the Y-axis of the chart,
r_{bottom} is the position of minimum value of the bottom of the Y-axis of the chart,
$${Object}_{range} = {Object}_{Top} - {Object}_{Bottom} ,$$
Object_{Top} is a position corresponding to the top of objects,
Object_{Bottom} is a position corresponding to the bottom of objects,
for the pie chart, the processor calculates the angle of the center of each sector by using [Equation 3], compares the angles of the centers of the sectors and considers the ratio of the angles of the centers of the sectors to determine a value corresponding to each sector
$$cos θ = \frac{2 {r}^{2} - {c}^{2}}{2 {r}^{2}} , \qquad [ Equation 3 ]$$
wherein θ is the angle of sector,
c is a distance between the two points constituting the arc of each sector, and
r is a distance between the center point of each sector and a point constituting the arc.

9-11. (canceled)

12. A non-transitory stored in a computer-readable storage medium having a program recorded therein to execute the method of claim 8 by using a computer device.
